(19) United States
(12) Patent Application Publication
(10) Pub. No.: US 2026/0199937 A1
(43) Pub. Date: Jul. 16, 2026

(54) X-RAY INSPECTION DEVICE

(71) Applicant: ANRITSU CORPORATION, Kanagawa (JP)

(72) Inventors: Takeshi TSUNODA, Kanagawa (JP); Kazunori NAKAYAMA, Kanagawa (JP); Naoya SAITO, Kanagawa (JP)

(21) Appl. No.: 19/439,564

(22) Filed: Jan. 5, 2026

(30) Foreign Application Priority Data
Jan. 16, 2025 (JP) 2025-006213

(51) Int. Cl. B07C 5/34; G01N 23/04; G01N 23/083; G06T 7/00; G06V 20/50

(52) U.S. Cl. CPC B07C 5/3416; G01N 23/04; G01N 23/083; G06T 7/0004; G01N 2223/401; G01N 2223/643; G06T 2207/10116; G06T 2207/30108; G06V 20/50; G06V 2201/06

(57) ABSTRACT

An X-ray inspection device includes an image processing unit that performs predetermined image processing on an X-ray inspection image of an article and outputs determination data indicating a quality state, a determination unit that determines whether or not the article is defective based on the determination data, a sorting information setting unit that sets a discharge direction corresponding to a determination result, a sorting unit that sorts the article, a sorting operation control unit that controls a sorting operation of the sorting unit on the article at a predetermined sorting timing based on the determination result of the determination unit, and a sorting check image generation unit that generates a sorting check pseudo NG image showing that the article is to be discharged in the predetermined discharge direction set by the sorting information setting unit based on the determination result of the determination unit, using a sorting check sample.

### TECHNICAL FIELD

The present invention relates to an X-ray inspection device, and more particularly to an X-ray inspection device including an inspection unit that performs image processing on an X-ray image of an article obtained by X-ray imaging and performs X-ray inspection and a sorting unit that executes a sorting operation in a discharge direction corresponding to an inspection result of the inspection unit.

### BACKGROUND ART

In the related art, X-ray inspection devices have been widely used that include an inspection unit that inspects the presence or absence of foreign matters, missing articles, defective shapes, and trapping in a packaging seal portion in a transported article, based on an X-ray image of the article, and a sorting unit that is provided on a downstream side of the inspection unit in a transport direction and sorts the inspected article in a discharge direction corresponding to an inspection result of the inspection unit.

In this X-ray inspection device, in general, a transport speed of the article is set such that stable inspection and sorting are performed in consideration of the transport speed and sorting capacity of the sorting unit. For example, a waiting time from the detection of the carrying-in of each article to the start of sorting is set as a sorting delay time, which is the sum of the time required for inspection in the inspection unit and the time from the output of inspection results to the start of a sorting operation, and the sorting operation is executed after the waiting time has elapsed.

In this type of X-ray inspection device according to the related art, for example, when the same article is determined to be NG for a plurality of inspection items, all NG (defective) articles are counted, the number of NG articles obtained by subtracting the number of good articles from the total number of articles inspected does not match the total number of NG counts, and the display of the inspection results is difficult to understand. In order to solve this problem, there is an X-ray inspection device that accumulates the number of times the article is distributed for each discharge direction such that an operator can accurately understand the number of articles for each discharge direction (for example, see Patent Document 1).

In addition, as another X-ray inspection device according to the related art, for example, a device is known that checks whether or not an article determined to be defective has passed through a predetermined discharge path during a discharging period of a sorter for the article determined to be defective or during a predetermined period synchronized with the discharging period, based on a defect determination result due to excess or shortage in the weight of a transported article and a detection output of a sensor that detects that an article, which is discharged according to the defect determination, has passed through a predetermined discharge path corresponding to defect details (for example, see Patent Document 2).

### RELATED ART DOCUMENT

### Patent Document

[Patent Document 1] JP-A-2011-206710

[Patent Document 2] JP-A-1993-322634

### DISCLOSURE OF THE INVENTION

### Problem that the Invention is to Solve

However, in the former X-ray inspection device according to the related art described above, not only the time required for the image processing and the determination process in the article inspection but also the article detection time and the operation check time required for the sorting operation during discharge and the control thereof can vary greatly depending on the required article transport speed, a difference in article type, and the like. This causes a problem where it takes a lot of time to set or adjust the timing of the sorting operation.

That is, when the sorting delay time from the detection of the carrying-in of an inspection article to the start of sorting and the sorting operation time required for the sorting operation after the sorting delay time are fixed to the preset time, it may not be possible to complete accurate image processing and determination process for all inspection items within the set time, resulting in determination errors. Therefore, when the operating conditions are changed according to the article to be inspected or the inspection item in order to avoid the determination errors, an operation is needed that prepares defective article samples for each inspection item or pseudo NG articles that simulate the defective article samples, runs the defective article samples or the pseudo NG articles through a production line equipped with the X-ray inspection device, and adjusts the sorting delay time and the sorting operation time to appropriate values.

Further, in this adjustment operation, it is necessary to know the discharge timing corresponding to the shape of the article, particularly, the length and transport speed of the article in the transport direction and to set the necessary sorting operation time for each discharge direction. In addition, since the operation timing also differs depending on the type of the sorting mechanism used, it is necessary to check the operation while actually transporting a sample of a defective article or a pseudo NG article for each defect type under the same conditions as actual inspection for each type of article, and it takes a lot of time to perform the adjustment operation.

In addition, when the number of inspection items is small, the start timing of the sorting operation is set earlier, which makes it possible to perform the sorting operation during a longer sorting operation period. However, when the number of inspection items is large, the image processing time for the X-ray image of the article obtained by X-ray imaging increases as the number of inspection items increases. Therefore, a strict setting is required in which there is little margin in the sorting delay time that defines the start timing of the sorting operation and the sorting operation time required for the subsequent sorting operation. Therefore, it takes a lot of time to set or adjust the timing for reliably executing the sorting operation.

The present invention is to solve the above-described problems of the related art, and an object of the present invention is to provide an X-ray inspection device that can easily, quickly, and accurately set and adjust the timing of a sorting operation, without using a defective article sample or a pseudo NG article for each inspection item.

### Means for solving the problem

According to an example of an embodiment of the present invention, there is provided an X-ray inspection device including: an image processing unit that performs predetermined image processing on an X-ray inspection image obtained by irradiating a transported article with X-rays and detecting the X-rays transmitted through the article with an X-ray detector and outputs determination data indicating a quality state of the article; a determination unit that determines whether or not the article is defective based on the determination data; a sorting information setting unit that sets a discharge direction corresponding to a determination result of the determination unit; a sorting unit that sorts the article in the discharge direction set by the sorting information setting unit according to the determination result of the determination unit; a sorting operation control unit that controls a sorting operation of the sorting unit on the article at a predetermined sorting timing based on the determination result of the determination unit and the setting of the sorting information setting unit; and a sorting check image generation unit that uses a sorting check sample as the article, generates a sorting check pseudo image showing that the article is to be distributed in a predetermined discharge direction set by the sorting information setting unit based on the determination result of the determination unit, based on an X-ray inspection image of the sorting check sample, and outputs the sorting check pseudo image to the image processing unit.

With this configuration, when the determination data in the determination unit is obtained from an X-ray inspection image of a sorting check sample of a good article by predetermined image processing in the image processing unit, the sorting check pseudo image is generated as the sample inspection image such that the determination result of the determination unit based on the determination data is a defect determination for the discharge direction set by the sorting information setting unit. Therefore, regardless of the number of discharge directions set in the sorting information setting unit, it is not necessary to prepare a defective article sample or a pseudo NG article for each inspection item, and it is possible to easily, quickly, and accurately set the timing of the sorting operation for the discharge direction for each inspection item.

According to another example of the embodiment of the present invention, the sorting check image generation unit may include an NG image storage unit that stores an image of a predetermined defective portion determined to be distributed in the predetermined discharge direction and an NG image generation unit that adds the image of the predetermined defective portion stored in the NG image storage unit to the X-ray inspection image of the sorting check sample of a good article to generate the sorting check pseudo image.

With this configuration, the sorting check pseudo image showing that the article is to be distributed in the set discharge direction based on the determination result of the determination unit is generated only by loading a good article sample in the same manner as in a normal inspection operation. Therefore, it is possible to easily, quickly, and accurately set the timing of the sorting operation for the discharge direction for each inspection item.

According to still another example of the embodiment of the present invention, the sorting information setting unit may further set the sorting timing, and the sorting operation control unit may control the sorting operation of the sorting unit based on the sorting timing set by the sorting information setting unit.

In this case, since the sorting timing corresponding to the discharge direction can be set, it is possible to execute the sorting operation by a more accurate discharge based on the sorting timing.

According to yet another example of the embodiment of the present invention, the X-ray inspection device may further include product recognition means for recognizing the article when the article is sorted in the predetermined discharge direction by the sorting unit. The sorting operation control unit may cause the sorting unit to perform a sorting operation at a provisional sorting timing based on a transport speed when the article is transported and set the provisional sorting timing as the sorting timing in the sorting information setting unit when the article correctly sorted in the predetermined discharge direction is recognized by the product recognition means.

In this case, when the product recognition means recognizes that the article has been correctly sorted in the predetermined discharge direction, the provisional sorting timing based on the transport speed of the article is set as the sorting timing. Therefore, it is possible to execute a more reliable operation check.

### Advantage of the Invention

According to the present invention, it is possible to provide an X-ray inspection device that can easily, quickly, and accurately set and adjust the timing of a sorting operation without using a defective article sample or a pseudo NG article for each inspection item.

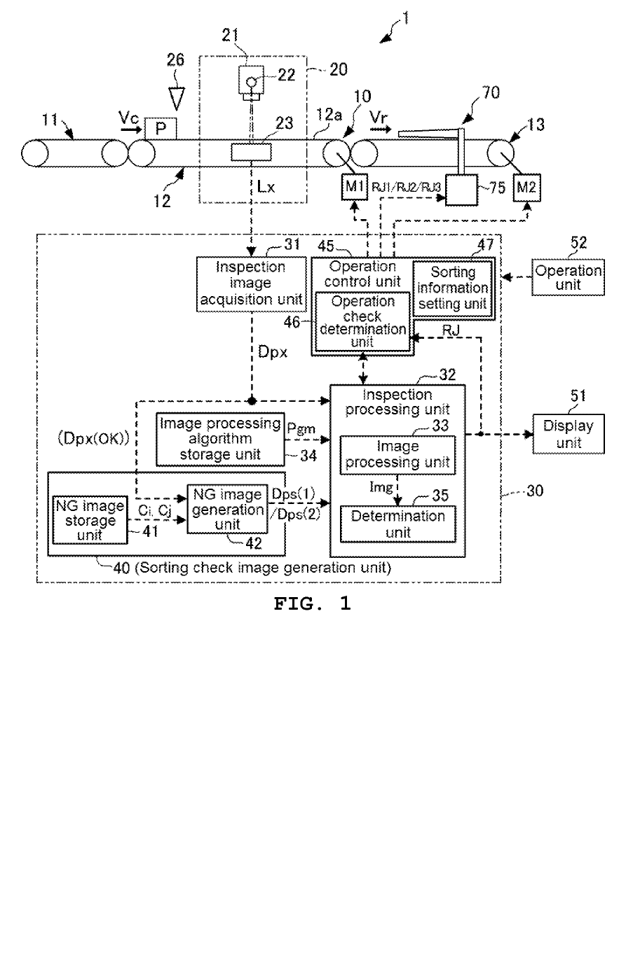

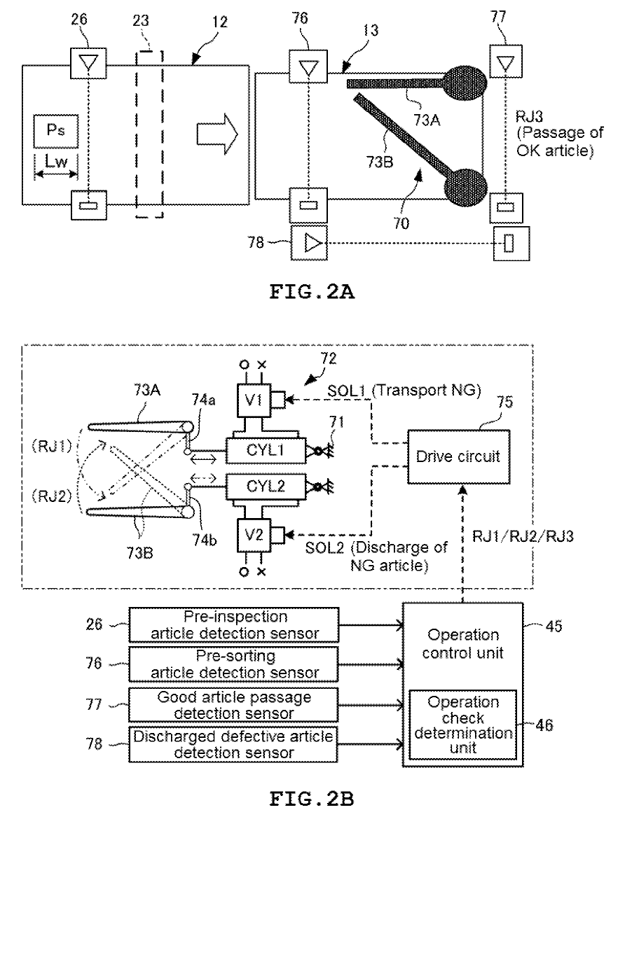

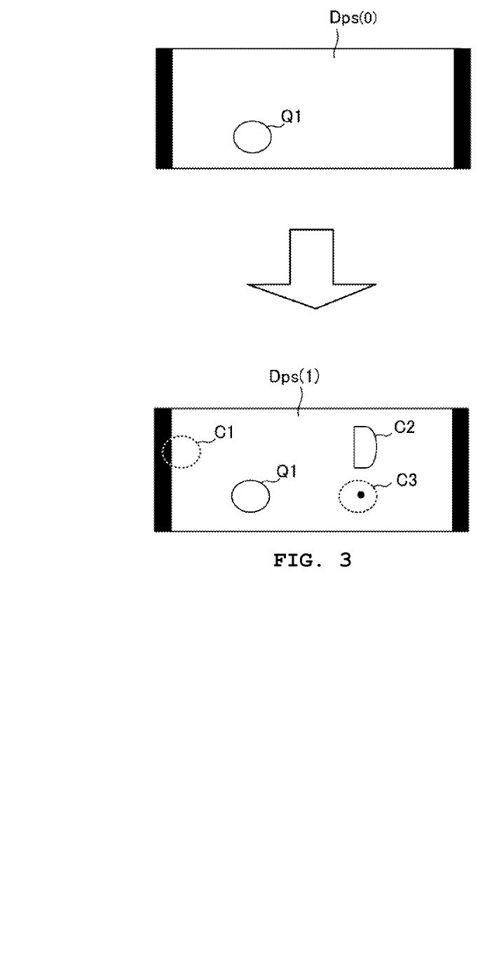

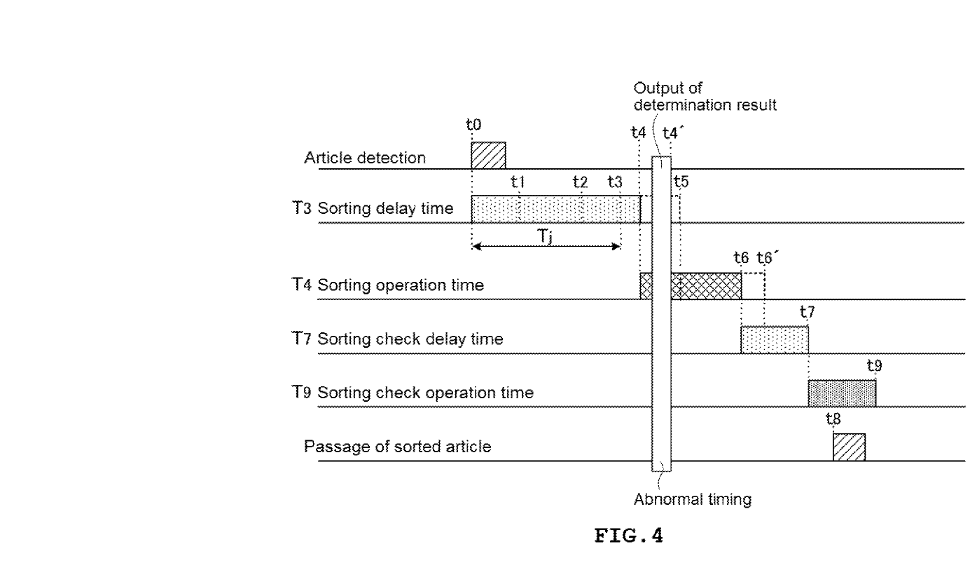

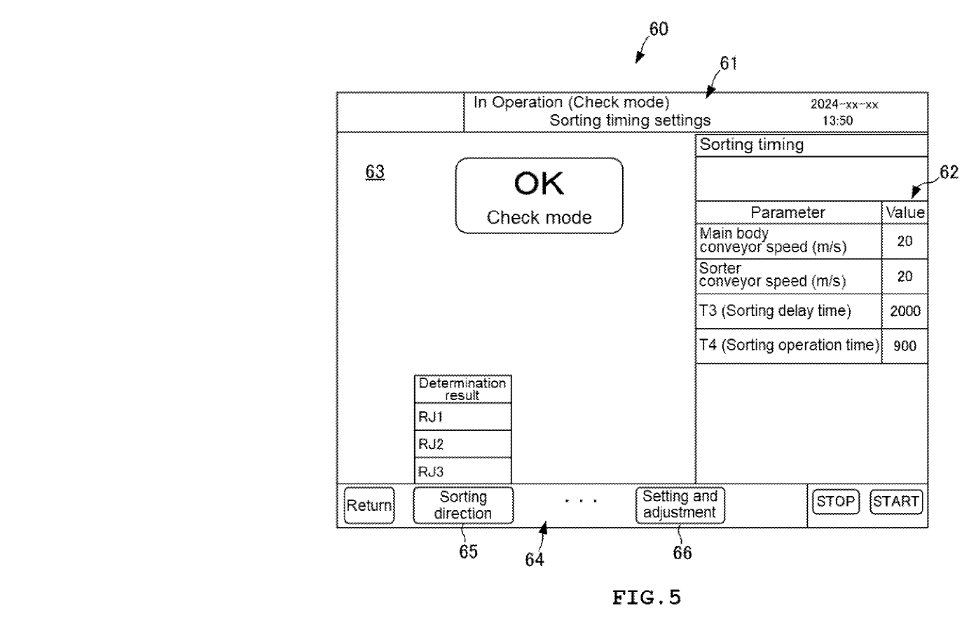

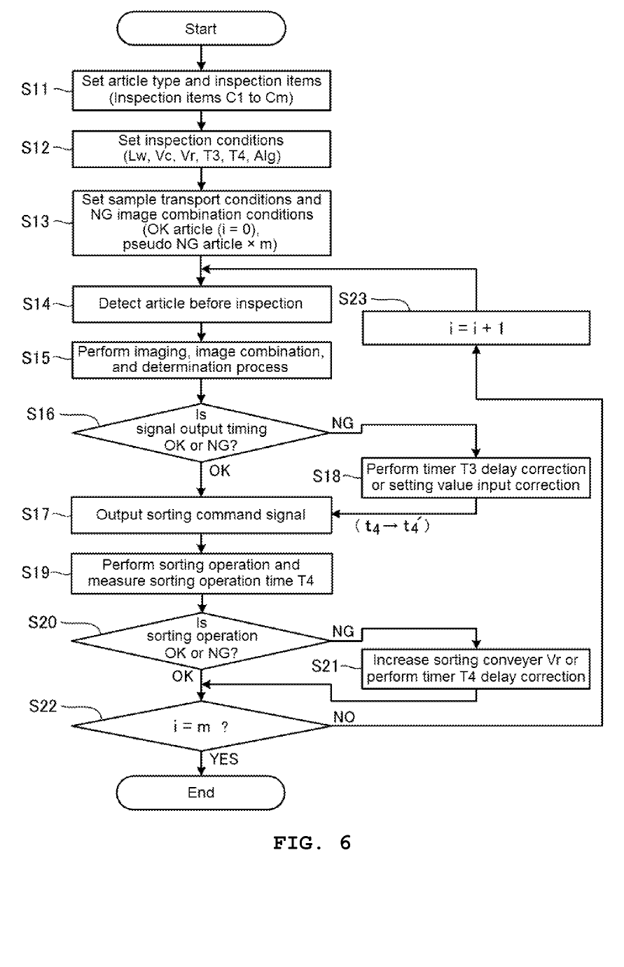

### BRIEF DESCRIPTION OF THE DRAWINGS

[FIG. 1] FIG. 1 is a schematic view showing a configuration of an X-ray inspection device according to an embodiment of the present invention.

[FIGS. 2A and 2B] FIG. 2A is a schematic plan view showing disposition of a plurality of types of sensors in the X-ray inspection device according to the embodiment of the present invention, and FIG. 2B is a schematic view showing a configuration of a drive control system of a sorting unit in the X-ray inspection device according to the embodiment of the present invention.

[FIG. 3] FIG. 3 is an explanatory view showing an example of a sorting check pseudo image obtained by adding images of a plurality of types of defective portions corresponding to a plurality of inspection items in an inspection unit to an X-ray image of a good article sample in the X-ray inspection device according to the embodiment of the present invention.

[FIG. 4] FIG. 4 is a timing chart showing a relationship among a sorting delay time T3 from the carrying of an article into the inspection unit to the start of a sorting operation to discharge by a sorting unit according to a determination result in the inspection unit, a sorting operation time T4 executed after the sorting delay time T3 has elapsed, a sorting check delay time T7 which is a waiting time for checking success or failure of the sorting operation and checking the operation, and a sorting check operation time T9 required for the sorting check in the X-ray inspection device according to the embodiment of the present invention.

[FIG. 5] FIG. 5 is an explanatory view showing a sorting timing setting screen for setting the sorting delay time and the sorting operation time for each inspection item in the X-ray inspection device according to the embodiment of the present invention.

[FIG. 6] FIG. 6 is a flowchart showing a control procedure for setting the sorting delay time and the sorting operation time for each inspection item and checking the operation in the X-ray inspection device according to the embodiment of the present invention.

### BEST MODE FOR CARRYING OUT THE INVENTION

Hereinafter, embodiments of the present invention will be described with reference to the drawings.

FIGS. 1 to 6 show an X-ray inspection device according to an embodiment of the present invention.

First, a configuration will be described.

As shown in FIG. 1 and FIGS. 2A and 2B, an X-ray inspection device 1 according to the present embodiment includes a transport unit 10 that transports an article P to be inspected along a predetermined transport path, an inspection unit 20 that performs predetermined image processing on an X-ray image (X-ray inspection image) of the article P obtained by imaging the article in the transport path with X-rays to inspect a quality state of the article P, a sorting unit 70 that operates in response to a sorting command signal RJ corresponding to an inspection result of the quality state and sorts the article P inspected by the inspection unit 20 in a discharge direction corresponding to the inspection result, and a control unit 30 that controls the transport unit 10, the inspection unit 20, and the sorting unit 70.

Further, in the present embodiment, the X-ray inspection device 1 in which the sorting unit 70 is disposed immediately after the inspection unit 20 is given as an example. However, the X-ray inspection system may be configured such that the inspection unit 20 and the sorting unit 70 are separated from each other, with another inspection device, a conveyor, or the like interposed therebetween, and are configured as an independent inspection device and an independent sorting device, respectively. In this case, the inspection device in the X-ray inspection system is the inspection unit according to the present invention, and the sorting device in the X-ray inspection system is the sorting unit according to the present invention.

The transport unit 10 is composed of a front-stage conveyor 11, an inspection conveyor 12, and a sorting conveyor 13 that are disposed in a row in a left-right direction in FIG. 1 and transport driving means therefor and is configured as a belt conveyor in which each loop-shaped conveyor belt is supported in a transportable and drivable manner by parallel driving and driven rollers and which can sequentially transport the articles P to the right in FIG. 1, which is not shown in detail. In addition, the transport driving means for the inspection conveyor 12 and the sorting conveyor 13 are configured to include motors M1 and M2 for transport driving, an encoder (not shown) for detecting a speed, and the like and are controlled by the control unit 30 such that a transport speed set for each type of article P is obtained.

The inspection unit 20 is an X-ray inspection unit including an X-ray generator 21 (X-ray source) that generates X-rays in a predetermined energy band transmitted through the article P transported by the transport unit 10 and an X-ray detector 23 that is disposed directly below a belt running section 12a of the inspection conveyor 12.

The X-ray generator 21 can generate X-rays having a wavelength and intensity corresponding to a tube current and a tube voltage of a known X-ray tube 22, using the X-ray tube 22, and can irradiate the article P in a predetermined inspection section on the inspection conveyor 12 with fan-beam X-rays which are spread in a direction orthogonal to an article transport direction of the transport unit 10, that is, in a scanning direction of the X-ray detector 23, through an X-ray window portion of an outer enclosure (not shown).

The X-ray detector 23 is, for example, an indirect-conversion-type X-ray line sensor using a scintillator, has, as detection elements, a plurality of photodiodes or charge coupled devices (CCDs) that receive scintillation light and are provided in an array at a predetermined pitch in a width direction of the transport path of the transport unit 10, and detects the X-rays at a predetermined resolution, which is not shown in detail. In addition, a direct-conversion-type semiconductor element may be used as the X-ray detector.

The X-ray detector 23 is disposed at a predetermined position in the transport direction corresponding to an irradiation position of X-rays from the X-ray generator 21. That is, the X-ray detector 23 can detect the X-rays which have been emitted from the X-ray generator 21 and transmitted through the article P for each predetermined transmission region corresponding to the detection elements, convert the X-rays into an electric signal corresponding to the amount of transmission of the X-rays, and output an X-ray detection signal Lx for generating an X-ray transmission image in which a transmission direction of the X-rays is an observation direction.

In addition, the X-ray detector 23 is configured to execute line scanning in the width direction at a predetermined cycle according to the transport speed of the inspection conveyor 12. When a pre-inspection article detection sensor 26 detects that the article P has been loaded onto the inspection conveyor 12, the control unit 30 causes the X-ray detector 23 to repeat the line scanning at least during an X-ray imaging period, (a transport direction length)/(a transport speed), of the article P and acquires the X-ray detection signal Lx for each scanning line. The pre-inspection article detection sensor 26 is configured as, for example, a photoelectric sensor that has an optical axis at a predetermined position on the inspection conveyor 12 in the transport direction and is shielded by the carried-in article P.

The control unit 30 is inspection control means for controlling the X-ray irradiation intensity and irradiation period of the inspection unit 20 or controlling, for example, the line scanning period of the X-ray detector 23 and the detection period of each article P corresponding to the transport speed of the article P and is also sorting control means for variably setting and controlling the output conditions of the sorting command signal RJ corresponding to the inspection result of the inspection unit 20 and the conditions of a sorting operation of the sorting unit 70 according to the type of the sorting command signal RJ and the type of the article P.

A detailed configuration of the control unit 30 is not shown, but the control unit 30 is implemented by, for example, a combination of hardware, such as a microcomputer (processor) having a CPU, a ROM, a RAM, and an I/O interface, and software, such as a program, that exhibits various functions on the hardware. The hardware mentioned here may include a field programmable gate array (FPGA), a digital signal processor (DSP), a graphics processing unit (GPU), and the like. In addition, the various functions mentioned here are a plurality of functions for performing the acquisition and output of detection data capable of generating an X-ray image of the article P, the generation of inspection image data, predetermined image processing, an inspection determination process, display output control, and the like and further include a timer function and a software management function of storing a control program and a program module for implementing each function in a ROM, an auxiliary storage device, or another recording medium so as to be readable or downloading the control program or the program module from another computer using data communication.

Specifically, the control unit 30 includes an inspection image acquisition unit 31, an inspection processing unit 32, and an image processing algorithm storage unit 34 as functional units for executing inspection based on the X-ray image of the article P among the plurality of functional units exhibiting the above-described various functions.

The inspection image acquisition unit 31 can sequentially acquire the X-ray detection signal Lx from the X-ray detector 23 as a line scanning image, store the X-ray detection signal Lx, and generate data Dpx of an inspection processing X-ray image (hereinafter, also referred to as captured image data Dpx) corresponding to a distribution of the amount of the X-rays transmitted through the article P.

Specifically, the inspection image acquisition unit 31 can generate the captured image data Dpx by performing A/D conversion on the X-ray detection signals Lx from the plurality of detection elements for each line scanning operation of the X-ray detector 23 and sequentially storing, in an image memory, cumulative transmission amount data per unit time as digital data that can be displayed in multi-gradation density levels, for example, from 0 to 1023 for all detection element regions of n detection elements (n is an integer greater than 1 and is, for example, 640).

The inspection processing unit 32 is configured to execute predetermined article inspection based on the captured image data Dpx of each article P from the inspection image acquisition unit 31 and includes an image processing unit 33 that acquires the captured image data Dpx output from the inspection image acquisition unit 31 and executes predetermined image processing, for example, one or more predetermined filtering processes that enable the extraction of image features and an image analysis process, such as feature measurement for calculating the feature amounts of the extracted image features, and a determination unit 35 that executes a determination process of determining whether or not a predetermined quality state of the article P is present based on data of the feature amounts extracted and measured by the image processing unit 33, for example, a process of determining whether or not a foreign matter is contained, whether or not a missing article is present, and whether or not the shape, size, or packaging state of a content is acceptable.

The image processing algorithm storage unit 34 stores a plurality of image processing algorithms Pgm, each of which can be used in the inspection processing unit 32, in the form of a control program, a program module, or the like that can be incorporated into the inspection processing unit 32 in association with the corresponding types of the articles P. In addition, the image processing algorithm storage unit 34 is connected to the inspection processing unit 32 in a data-transmissible manner such that at least the image processing algorithm (which may include a determination processing algorithm used in the determination unit 35) used in the image processing unit 33 can be updated to a new version or changed to a version having different functions.

Further, the inspection processing unit 32 is configured to display and output the determination results of the determination unit 35 to a display unit 51 (display device). The control unit 30 is configured to, when an operation of selecting an article type or an operation of requiring switching of the article type is input from an operation unit 52 that is provided together with the display unit 51, request the image processing algorithm storage unit 34 to perform the incorporation and setting of a specific image processing algorithm Pgm corresponding to the requested article type from the operation unit 52, including a necessary download operation from the outside. The display unit 51 and the operation unit 52 may be integrally provided in the form of a touch panel or the like, or a tablet terminal or the like may be provided together.

A predetermined image processing algorithm Pgm in which an image processing filter and the like have been combined is set and stored in the image processing unit 33 of the inspection processing unit 32 so as to be updatable and switchable, in order to execute a predetermined article inspection based on the captured image data Dpx of the article P acquired from the inspection image acquisition unit 31.

The image processing filter included in the image processing algorithm Pgm of the image processing unit 33 is a processing program for extracting image features (for example, an edge, a line, an angle, a region, shading, and a texture) necessary for a predetermined article inspection based on the captured image data Dpx of the article P. When the image processing algorithm Pgm includes a foreign matter detection filter, the image processing filter has a feature extraction filter that performs an edge detection process of emphasizing the contour of a foreign matter in the article P, for example, a differential filter, such as a Sobel filter, and performs a differential process or the like based on a predetermined arithmetic expression on a region near a pixel of interest to emphasize the edge of the foreign matter. In addition, the image processing filter or the like includes not only the feature extraction filter but also pre-processing thereof, such as shading correction or noise removal, on the captured image data Dpx from the inspection image acquisition unit 31 in order to improve the accuracy of the image feature detection process.

Further, the feature measurement of the image features executed by the image processing unit 33 is a process of executing the calculation of attributes (feature amounts characterizing an edge, a region, a distance, a position, a shape, and the like) related to, for example, shading features, color features, shape features, and the like, the calculation of feature amounts representing a spatial relationship between these features, or the calculation of texture feature amounts related to a spatial frequency distribution and a direction component for the image obtained by performing necessary pre-processing or image processing on the captured image data Dpx of the article P acquired from the inspection image acquisition unit 31, thereby calculating feature amounts required for the determination process of the determination unit 35.

The determination unit 35 detects the feature shape, the foreign matter, or the like detected from the article P based on the feature amounts obtained by feature extraction and measurement by the image processing unit 33, or compares the feature amounts, such as the area, contour length, and density sum of the object to be detected, with limits which are predetermined determination reference values to execute a determination process of determining whether or not the article P includes a foreign matter satisfying defect determination conditions, a local feature shape corresponding to a defective portion, or the like.

As described above, the inspection processing unit 32 applies a predetermined image processing algorithm Pgm, in which a plurality of filtering processes and the like have been combined, to the captured image data Dpx of a predetermined type of article P or the image data obtained by performing necessary pre-processing or image processing on the captured image data Dpx to generate an image that enables the determination of a predetermined quality state of the article P.

In addition, the image processing algorithm storage unit 34 stores in advance a plurality of image processing algorithms (which may further include the determination processing algorithm that can be used in the determination unit 35) that can be used at least in the image processing unit 33 and that perform predetermined image processing. The image processing unit 33 of the inspection processing unit 32 and the image processing algorithm storage unit 34 have a function of updating or switching the image processing algorithm Pgm being used in the inspection processing unit 32 to a specific image processing algorithm Pgm corresponding to a newly set article type when a request to switch or update to another article type is made from the inspection processing unit 32 based on the operation of selecting or switching the article type from the operation unit 52.

Meanwhile, the sorting unit 70 includes a support frame 71 that supports the sorting conveyor 13, a pair of sorting members that are rotatably supported by the support frame 71 and are located on both sides of the sorting conveyor 13 in the width direction of the transport path, for example, sorting arms 73A and 73B, a discharge mechanism 72 that has a pair of air cylinders CYL1 and CYL2, lever members 74a and 74b, and valves V1 and V2 (not shown in detail), and a drive circuit 75 for the discharge mechanism 72.

When the valves V1 and V2 are electromagnetically operated by the drive circuit 75, the discharge mechanism 72 can perform a sorting operation in a first sorting posture in which the rotation position of any one of the sorting arms 73A and 73B is located above the inspection conveyor 12, for example, in an article discharging posture represented by a dotted virtual line in FIG. 2B or can return to a second sorting posture, in which any one of the sorting arms 73A and 73B in the first sorting posture is retracted from above the inspection conveyor 12, for example, a standby posture in which the sorting arms are parallel to the transport direction as represented by a solid line in FIG. 2B, in response to the input of the electromagnetic operation.

The drive circuit 75 can selectively supply operation signals SOL1 and SOL2 (see FIG. 2B) corresponding to the type of the sorting command signal RJ to the valves V1 and V2, for example, supply and discharge control valves (which may be direction control valves and speed control valves) that controls the supply and discharge of air (compressed air) to independently control the expansion and contraction operations of a pair of air cylinders CYL1 and CYL2 through the valves V1 and V2, respectively. The drive circuit 75 controls the sorting arms 73A and 73B to relative postures corresponding to the type of the sorting command signal RJ or a sorting start timing through the discharge mechanism 72 such that the article P can be distributed in any of three different discharge directions, that is, the article P can be discharged to the left side relative to the transport direction, can be distributed and discharged to the right side, or can pass straight through.

The sorting unit 70 is also provided with a pre-sorting article detection sensor 76 that is located at a predetermined position in the transport direction near the entrance of the sorting conveyor 13, product recognition means for recognizing the passage of the article P in each discharge direction, for example, a good article passage detection sensor 77 that detects the passage of a good article (OK article) near the exit of the sorting conveyor 13, and a discharged defective article detection sensor 78 that detects a defective article P discharged from the transport path when the sorting arm 73B is in an article discharging posture (an inclined posture shown in FIG. 2A).

Each of the pre-sorting article detection sensor 76, the good article passage detection sensor 77, and the discharged defective article detection sensor 78 is configured as a photoelectric sensor that has an optical axis represented by a dotted line in FIG. 2A, similarly to the pre-inspection article detection sensor 26. The pre-sorting article detection sensor 76 detects the article P that has reached a sorting region when light is shielded by the article P carried onto the sorting conveyor 13. The good article passage detection sensor 77 detects the passage of a good article when light is shielded by the article P that has been determined to be a good article and has passed through the sorting region. The discharged defective article detection sensor 78 detects the passage of a defective article when light is shielded by the defective article P discharged from the transport path by the sorting arm 73B.

The control unit 30 has a sorting check image generation unit 40, an operation control unit 45, an operation check determination unit 46, and a sorting information setting unit 47 as functional units for controlling the sorting operation of the sorting unit 70 and checking the operation of the inspection unit 20 and the sorting unit 70 among the plurality of functional units described above.

The sorting check image generation unit 40 generates a sorting check pseudo image for checking whether or not there is an abnormality in the sorting operation of the inspection unit 20 in each discharge direction based on the captured image data Dpx of a sorting check sample Ps of a good article.

Specifically, the sorting check image generation unit 40 includes an NG image storage unit 41 that stores typical NG feature images having features of a predetermined defective portion determined to be distributed in the discharge direction for each defect type and an NG image generation unit 42 that combines and adds the NG feature image of a predetermined defect type stored in the NG image storage unit 41 to a sample image of a good article image, for example, a good article sample image Dps(0) shown in FIG. 3 to generate a sorting check pseudo NG image Dps(1).

That is, when the X-ray transmission image Dps(0) shown on the upper side in FIG. 3 is obtained as the entire image of the sorting check sample Ps based on the captured image data Dpx(OK) (see FIG. 1) of the sorting check sample Ps of the good article, the sorting check image generation unit 40 combines and adds a partial NG feature image stored in advance in the NG image storage unit 41 of the sorting check image generation unit 40 to the X-ray transmission image Dps(0) to generate, as the sorting check pseudo NG image Dps(1), a pseudo NG image that has overall image features similar to those of the X-ray transmission image Dps(0) of the sorting check sample Ps, but partially has defective features corresponding to the NG feature image.

In addition, as shown in FIG. 3, the sorting check image generation unit 40 combines and adds, for example, NG feature images of some of a plurality of defect types stored in advance in the NG image storage unit 41 to the X-ray transmission image Dps(0) of the sorting check sample Ps of the good article P to create a sorting check pseudo NG image Dps(1) having NG feature images Ci and Cj (here, C is an NG feature, and i and j are any natural numbers different from each other) of each defect type for a plurality of inspection items that can be simultaneously applied to the article P whose type has been selected. For example, an upper FIGURE(X-ray transmission image Dps(0)) of FIG. 3 shows that a good article partial image feature Q1 of the article P of the sorted type is included in a solid circle frame. A lower FIGURE(sorting check pseudo NG image Dps(1)) shows that an NG feature image C1 indicating a defective state, such as a trapping seal portion in a flexible packaging, seal misalignment, or the containment of a foreign matter, is included in a dotted circle frame, shows an NG feature image C2 obtained by differentially processing a partial image of a content of a soft packaging product into any shape or ratio suitable for the sorted article type, and shows that an NG feature image C3 of any foreign matter sample or test piece, which can be contained in the article P, is included in a dotted circle frame. Then, it is possible to generate the sorting check pseudo NG image Dps(1) having the NG feature images and the good article partial image.

Of course, when a plurality of discharge directions are set for a plurality of inspection items that can be simultaneously applied to the article P whose type has been selected, the sorting check image generation unit 40 can selectively combine and add one or more corresponding NG feature images Ci or Cj among the NG feature images of a plurality of defect types stored in advance in the NG image storage unit 41 in each discharge direction to generate a sorting check pseudo image Dps(2) (see FIG. 1) having the NG feature image Ci or Cj of the defect type or a good article sorting check pseudo image Dps(2) for any one of the inspection items that can be applied to the article P, whose type has been selected, each time the X-ray transmission image Dps(0) of the sorting check sample Ps of the good article P is acquired. In addition, when a plurality of sorting check samples Ps of the good article P are loaded or when the article passes through the inspection unit 20 a plurality of times, a plurality of sorting check pseudo images Dps (2) corresponding to a plurality of types of inspection items can be generated.

The control unit 30 can switch between a normal inspection operation mode in which the captured image data Dpx output from the inspection image acquisition unit 31 is directly input to the inspection processing unit 32 and an operation check mode (which may be a test mode, a maintenance mode, or the like in which inspection and sorting operations can be checked) in which the captured image data Dpx output from the inspection image acquisition unit 31 is input as the sorting check pseudo NG image Dps(1) via the sorting check image generation unit 40.

In addition, in the operation check mode, the control unit 30 sets the image, which is output from the sorting check image generation unit 40 according to the selected article type, as at least one sorting check pseudo NG image Dps(1) and/or a plurality of sorting check pseudo images Dps(2), based on the number of discharge directions set in the sorting unit 70 according to the defect type of the article P. Further, the number of discharge directions is set in the sorting unit 70 such that, when the start timing of the sorting operation does not fall within a time range in which the normal operation is possible, a discharge direction in which the article P is discharged from the normal article transport line is further set, in addition to the discharge direction corresponding to the defect type of the article P (this will be described below).

The operation control unit 45 has a function of variably controlling the speeds of the motors M1 and M2 for transport driving of the inspection conveyor 12 and the sorting conveyor 13 according to the type of the article P and the inspection item and a function of selectively outputting the operation signals SOL1 and SOL2 to the drive circuit 75 or outputting neither of the operation signals SOL1 and SOL2 according to the type of the sorting command signal RJ from the inspection processing unit 32 and the appropriateness of the sorting start timing. Here, the type of the sorting command signal RJ is, for example, the defect type of a defective article corresponding to any one of the NG feature images C1, C2, and C3.

In addition, the operation check determination unit 46 is provided in the operation control unit 45. The operation check determination unit 46 determines whether or not a determination result output timing is appropriate before the output of the determination result (OK/NG) to the display unit 51 and the output of the sorting command signal RJ immediately before a sorting delay time T3 elapses after a leading end of the article P carried onto the inspection conveyor 12 is detected by the pre-inspection article detection sensor 26, for example, when a required determination time Tj up to a time point t3 at which the determination process of the determination unit 35 ends has elapsed. Therefore, the detection signals from each of the pre-inspection article detection sensor 26, the pre-sorting article detection sensor 76, the good article passage detection sensor 77, and the discharged defective article detection sensor 78 are input to the operation control unit 45.

The appropriateness of the sorting start timing mentioned here means whether the timing, which differs depending on whether or not the sorting command signal RJ is output from the inspection processing unit 32 until the predetermined sorting delay time T3 elapses after the detection of the carrying-in of the article P by the pre-inspection article detection sensor 26, is appropriate. That is, the above means the following: when the output timing of the sorting command signal RJ for the article P to be inspected is appropriate, it is possible to secure a sufficient sorting operation time T4 to shift the sorting arm 73B for discharging defective articles from the posture in which the sorting arm 73B is parallel to the other sorting arm 73A to the article discharging posture (the inclined posture represented by the dotted line in FIG. 2B), thereby discharging the article P to be inspected as a defective article; however, when the output timing of the sorting command signal RJ for the article P to be inspected is not appropriate, it is not possible to secure a sufficient sorting operation time T4 to shift the sorting arm 73B for discharging defective articles from the posture in which the sorting arm 73B is parallel to the other sorting arm 73A to the article discharging posture, thereby discharging the article P to be inspected as a defective article.

When the sorting command signal RJ is output from the inspection processing unit 32 after the predetermined sorting delay time T3 has elapsed since the detection of an article by the pre-inspection article detection sensor 26, the drive circuit 75 generates the sorting operation signal SOL1 in response to the sorting command signal RJ1 output from the operation control unit 45, and the connection between the supply pressure (O) and drain (X) of a control pressure port on the primary side and a control pressure port of the air cylinder CYL1 on the secondary side in the solenoid-operated valve V1 can be switched by the sorting operation signal SOL1 to switch the air supply and discharge state of a pair of air supply and discharge ports of the air cylinder CYL1 to a cylinder contraction side (the side on which a transport NG article is discharged).

Meanwhile, the drive circuit 75 generates the sorting operation signal SOL2 in response to the sorting command signal RJ2 selectively output from the operation control unit 45 when the sorting command signal RJ is output from the inspection processing unit 32 before the predetermined sorting delay time T3 has elapsed since the detection of an article by the pre-inspection article detection sensor 26. That is, the sorting operation signal SOL2 is generated when the inspection processing unit 32 issues an instruction to sort and discharge a defective article using the sorting command signal RJ and the output timing of the sorting command signal RJ for the article P to be inspected is appropriate, and the connection between the supply pressure (O) and drain (X) of a control pressure port on the primary side and a control pressure port of the air cylinder CYL2 on the secondary side in the solenoid-operated valve V2 can be switched by the sorting operation signal SOL2 to switch the air supply and discharge state of a pair of air supply and discharge ports of the air cylinder CYL2 to a cylinder contraction side (the side on which the defective article is discharged).

When the determination result of the determination unit 35 is OK within the predetermined sorting delay time T3 from the detection of an article by the pre-inspection article detection sensor 26 and the sorting command signal RJ is not output from the inspection processing unit 32, the operation control unit 45 outputs a sorting command signal RJ3 during the passage period of the article P to be sorted. At that time, the drive circuit 75 outputs neither of the sorting operation signals SOL1 and SOL2. In this case, for example, when the air cylinders CYL1 and CYL2 are a single-acting type, the sorting arms 73A and 73B can be returned to the standby posture, in which the sorting arms 73A and 73B are parallel to each other, by return springs provided in the air cylinders CYL1 and CYL2. In addition, when the air cylinders CYL1 and CYL2 are not the single-acting type, for example, a centering spring can be provided in each of the air cylinders CYL1 and CYL2, and a neutral position can be provided in direction control valves of the valves V1 and V2 to return the sorting arms 73A and 73B to the standby posture in which the sorting arms 73A and 73B are parallel to each other (the posture in which the passage of a good article is allowed).

The sorting information setting unit 47 also functions as a setting value memory in the operation control unit 45. In the sorting information setting unit 47, information, in which identification codes of each inspection item and a sorting operation direction in which a defective article occurring for the inspection item is discharged by the sorting unit 70 are associated with each other for each type of article P to be inspected, is set as sorting information by operation input from the operation unit 52 or data communication input to the control unit 30, and the setting value thereof is stored in the form of a table or the like. In addition, the sorting information setting unit 47 sets the sorting timing as the sorting delay time T3 and the sorting operation time T4 for each type of article P, in addition to setting the discharge direction. The sorting operation control unit 45 causes the sorting unit 70 to execute the sorting operation based on the sorting timing set by the sorting information setting unit 47. The article type mentioned here includes a type name or a code that enables identification of the type of the article P to be inspected, identification codes of one or more inspection items to be applied, and the setting value of the transport speed.

Further, in the operation control unit 45, a sorting check delay time T7 and a sorting check operation time T9 are set to be updatable and stored in the sorting information setting unit 47. When the good article P on the sorting conveyor 13 is moved straight and a defective article is discharged by the sorting unit 70 according to the sorting command signals RJ2 and RJ3 output from the operation control unit 45, the passage of the article P in each discharge direction is detected by the good article passage detection sensor 77 and the discharged defective article detection sensor 78, and it can be determined that the corresponding sorting operation is normally executed in a predetermined discharge direction.

FIG. 4 shows changes in sensor signals and timer operations when the control unit 30 causes the operation control unit 45 and the operation check determination unit 46 to operate as described above.

### Normal Inspection Operation Mode

As shown in FIG. 4, when the leading end of the article P carried onto the inspection conveyor 12 is detected by the pre-inspection article detection sensor 26, the timer measurement of a predetermined sorting delay time T3 from a time point t0 at which the leading end is detected is started. After the timer measurement of the sorting delay time T3 has been completed (the time has elapsed), the timer measurement of the sorting operation time T4 by the sorting unit 70 is started.

Here, for example, when the type of the article P is set or when the type is switched, the predetermined sorting delay time T3 is stored as a timer setting value for each article type in the setting value memory of the inspection processing unit 32 such that it can be rewritten and is also stored in an adjustment memory of the operation control unit 45 such that it can be rewritten.

The predetermined sorting delay time T3 is a waiting time required until the inspection image acquisition unit 31 acquires the captured image data Dpx of the article P, the image processing unit 33 executes predetermined image processing, such as a filtering process, and an image analysis process, such as feature measurement, a determination process of determining the presence or absence of a predetermined quality state of the article P based on the results of the predetermined image processing and the image analysis process is executed, and the sorting command signal RJ corresponding to the determination result is output.

Specifically, as shown in an example in FIG. 4, in the predetermined sorting delay time T3, the required determination time Tj composed of the time point t1 at which the captured image data Dpx of the article P is acquired by the inspection image acquisition unit 31 following the detection of the leading end of the article P by the pre-inspection article detection sensor 26, a time point t2 at which the predetermined image processing and the image analysis process in the image processing unit 33 are completed, and the time point t3 at which the determination process in the determination unit 35 is ended is the main time. The timer measurement of the sorting delay time T3 is completed at a time point t4 at which the sorting command signal RJ corresponding to the result of the determination process in the determination unit 35 is output.

During the timer measurement of the sorting operation time T4 that starts from the time point t4 at which the sorting command signal RJ is output, the sorting unit 70 executes a sorting operation corresponding to the sorting command signal RJ from the inspection processing unit 32. Therefore, in the normal inspection operation in which the operation timing has been adjusted in advance, the sorting operation is normally completed during the sorting operation time T4.

When the timer measurement of the sorting operation time T4 is completed, the timer measurement of a predetermined sorting check delay time T7 for checking the success or failure of the sorting operation is started from a time point t6. When the timer measurement of the sorting check delay time T7 is completed, the timer measurement of a sorting check operation time T9 is started from a time point t7.

Then, when the optical axis of the discharged defective article detection sensor 78 is shielded by the defective article P discharged from the transport path by the sorting arm 73B and the passage of the article in the defective article discharge direction is detected during the sorting check operation time T9, it is possible to confirm that the inspection of the article based on the X-ray image in the inspection unit 20 has resulted in a defect determination and the sorting operation to discharge the defective article P by the sorting unit 70 has been completed normally.

### Operation Check Mode

Meanwhile, when the operation is executed in the normal inspection operation mode after the operation of registering or switching the type of the article P is input by the operation unit 52, the number of inspection items may be large, and the processing time required for predetermined image processing may be longer than usual. In this case, as shown as an abnormal timing in FIG. 4, the determination process in the determination unit 35 cannot be ended until the required determination time Tj elapses, and the sorting command signal RJ corresponding to the result of the determination process in the determination unit 35 cannot be output until the time point t4 at which the timer measurement of the sorting delay time T3 is completed.

Therefore, in the present embodiment, after the operation of registering or switching the type of the article P is input, the sorting check sample Ps of that type of good article is passed through the inspection unit 20 and subjected to X-ray imaging. In this case, in the sorting check image generation unit 40, a pseudo NG image, which has overall image features similar to those of the X-ray transmission image Dps(0) of the sorting check sample Ps, but partially has defective features corresponding to the NG feature image, is generated as the sorting check pseudo NG image Dps(1).

Then, when a plurality of types of inspection items requiring extended processing time are needed for the sorting check pseudo NG image Dps(1) and the processing time is longer than usual, the operation control unit 45 determines that the sorting command signal RJ cannot be output by the timer measurement completion time point t4 of the sorting delay time T3, at the time point t3 at which the required determination time Tj has elapsed.

In this case, the control unit 30 displays and outputs, for example, an operation screen 60 for setting a sorting timing shown in FIG. 5 on the display unit 51.

The operation screen 60 includes, for example, an operation state display region 61 in which what kind of operation state the X-ray inspection device 1 is in, a setting information display region 62 in which a plurality of types of setting value information related to the sorting timing for the current article type are displayed with each parameter name and setting value, a selection operation display region 63 in which options, operation descriptions, operation input elements, and the like corresponding to the operation input are displayed, and an operation button display region 64 in which operation portion images of a plurality of operation buttons and the like are displayed in an aligned manner and which functions as a portion of the operation unit 52. Then, a sorting direction selection operation button 65 for selecting a sorting direction for operation check, a setting and adjustment operation button 66 that can be used to input the transport speed of the article P and the set time for each timer measurement, and the like are displayed in the operation button display region 64.

On the operation screen 60, when a touch operation on the sorting direction selection operation button 65 is performed, the sorting directions (RJ1, RJ2, and RJ3 in FIG. 5) are displayed in an expandable format such that one of the sorting directions can be selected, which makes it possible to check the operation in the selected sorting direction. In addition, when a touch operation on the setting and adjustment operation button 66 is performed, it is possible to input the setting value of any parameter of the transport speed of the inspection conveyor 12 (the speed of a main body conveyor [m/s] in FIG. 5), the transport speed of the sorting conveyor 13 (the speed of a sorter conveyor [m/s] in FIG. 5), the sorting delay time T3, and the sorting operation time T4.

The operation control unit 45 executes an operation check process on the transported sorting check sample Ps, using the parameters set and input through the operation screen 60, and displays a sorting check result (for example, OK) in the operation check mode. In addition, when the sorting delay time T3 is displayed as a portion of the parameters set and input through the operation screen 60 and an operation for changing the sorting delay time T3 is not input within a predetermined period of time, for example, a delay time expiration time point t4' that is a predetermined adjustment unit time after the timer measurement completion time point t4 of the sorting delay time T3 may be set as the sorting delay time when the sorting command signal RJ can be output. In addition, the sorting delay time T3 may be calculated as a waiting time corresponding to the type of the sorting command signal RJ based on the length of the article P of a newly selected type in the transport direction and the transport speed of the article P and may be displayed as a candidate value for the parameter setting value in the setting information display region 62 to be highlighted, or a supplementary explanation may be displayed in the selection operation display region 63.

In this case, it is possible to output the sorting command signal RJ by the delay time expiration time point t4’ and to start the timer measurement of the sorting operation time T4 from the delay time expiration time point t4' or a start time point t5 immediately after the delay time expiration time point t4'. In addition, the operation control unit 45 rewrites the value of the sorting delay time T3 stored in the built-in adjustment memory to a time value up to the delay time expiration time point t4’ reset from the time point t0 at which the leading end of the article P is detected by the pre-inspection article detection sensor 26.

In addition, when the inspection processing unit 32 outputs the sorting command signal RJ after the sorting delay time T3 has elapsed, the operation control unit 45 outputs the sorting command signal RJ1 to request the sorting operation signal SOL1 by the delay time expiration time point t4’ to the drive circuit 75 of the sorting unit 70. In this case, the solenoid-operated valve V1 is operated by the sorting operation signal SOL1 from the drive circuit 75, and the air supply and discharge state to the air cylinder CYL1 is switched to the cylinder contraction side. Therefore, the sorting arm 73A is driven to the article discharging posture represented by a two-dot chain line in FIG. 2B, and the sorting check sample Ps of the good article is discharged. Further, the sorting command signal RJ1 may be output at a time point at which the sorting check sample Ps of the good article, which is the article P to be sorted, approaches the sorting unit 70 too closely and is detected by the pre-sorting article detection sensor 76 before the output of the sorting command signal RJ.

When the operator passes the sorting check sample Ps of the good article through the inspection unit 20 again, X-ray imaging is performed again, and an X-ray transmission image Dps(0) is acquired again. The sorting check image generation unit 40 generates a sorting check pseudo NG image Dps(1). However, a plurality of types of inspection items requiring extended processing time are needed for the sorting check pseudo NG image Dps(1), and the processing time is longer than usual. When it is determined at the time point t3 at which the required determination time Tj has elapsed that the sorting command signal RJ can be output by the delay time expiration time point t4' of the sorting delay time T3, a time value up to the delay time expiration time point t4’ reset from the time point t0 at which the leading end of the article P is detected by the pre-inspection article detection sensor 26 is determined to be the value of the sorting delay time T3.

In this case, when it is not determined that the sorting command signal RJ can be output by the delay time expiration time point t4', the sorting check result is displayed as NG, and the above-described operation check operation using the sorting check sample Ps of the good article is requested again. Then, the delay time expiration time point t4' is changed to a time value that is further delayed by a predetermined adjustment unit time or an input setting value.

On the other hand, even when the sorting delay time T3 is appropriate, the sorting operation to discharge by the sorting unit 70 may not be executed normally since the sorting operation time T4 immediately after the sorting delay time T3 is not appropriate.

Therefore, in the operation check mode, first, during the timer measurement of the sorting operation time T4, the sorting unit 70 executes the sorting operation corresponding to the sorting command signal RJ from the inspection processing unit 32.

In this case, when the sorting operation is normally completed during the sorting operation time T4, the sorting operation time T4 can be determined. However, in order to determine the sorting operation time T4, when the timer measurement of the sorting operation time T4 is completed, the timer measurement of a predetermined sorting check delay time T7 for checking the success or failure of the sorting operation is started from the time point t6. When the timer measurement of the sorting check delay time T7 is completed, the timer measurement of a sorting check operation time T9 is started from the time point t7.

Then, when the optical axis of the discharged defective article detection sensor 78 is shielded by the defective article P discharged from the transport path by the sorting arm 73B and the passage of the article P in the defective article discharge direction is detected during the sorting check operation time T9, it is possible to confirm that the inspection of the article based on the X-ray image in the inspection unit 20 has resulted in a defect determination and the sorting operation to discharge the defective object P by the sorting unit 70 has been completed normally.

On the other hand, when the passage of the article in the defective article discharge direction is not detected and the sorting operation to discharge the defective article P by the sorting unit 70 has not been normally completed even though the inspection of the article based on the X-ray image in the inspection unit 20 results in a defect determination during the sorting check operation time T9, the operation control unit 45 changes the setting of the timer measurement completion time point t6 to an operation time expiration time point t6' that is delayed by a predetermined adjustment unit time, or calculates the sorting operation time T4 as the waiting time corresponding to the type of the sorting command signal RJ based on the length of the article P of a newly selected type in the transport direction, the transport speed of the sorting conveyor 13, and the like. In addition, the value may be displayed as a candidate value for the parameter setting value in the setting information display region 62 to be highlighted, or a supplementary explanation may be displayed in the selection operation display region 63.

Then, when the sorting operation is normally completed during the sorting operation time T4, the sorting operation time T4 can be determined. In addition, the timer measurement completion time point t6 of the sorting operation time T4 is changed to the completion time point t6' that is delayed by the above-mentioned adjustment unit time, but the sorting check delay time T7 is shortened by the above-described adjustment unit time, without delaying the timer measurement start timing of the sorting check delay time T7 from the original timer measurement completion time point t6 of the sorting operation time T4. Therefore, when the sorted article passes through during the sorting check operation time T9, the sorting check delay time T7 can be set to be shortened. In other cases, the sorting check delay time T7 can be corrected to be delayed by the above-described adjustment unit time.

When the adjustment of the sorting delay time T3 and the sorting operation time T4 is completed, for example, the sorting check pseudo image Dps(2) having the NG feature images Ci or Cj of defect types with different discharge directions is generated while the good article P is transported and inspected the number of times corresponding to the number of inspection items. In this way, it is possible to check the sorting operation of the sorting unit 70 and to check the discharge in the sorting direction.

Alternatively, it is possible to check the sorting operation of the sorting unit 70 and to check the discharge in the sorting direction while transporting and inspecting a plurality of good articles P in each discharge direction.

Next, actions will be described.

When the article type is registered in the X-ray inspection device 1 according to the present embodiment or when the content of the article type setting is switched, the control unit 30 executes a control program for operation check and a timing adjustment operation in a processing procedure shown in FIG. 6.

First, after an article type and a predetermined number of inspection items (C1 to Cm) are set by the operation input from the operation unit 52 (Step S11), a length Lw of the article P, a transport speed Vc of the inspection conveyor 12, and a transport speed Vr of the sorting conveyor 13, which are inspection conditions of each inspection item, are set, each of the sorting delay time T3 and the sorting operation time T4, which define the standard sorting timing of the sorting unit 70, is calculated based on the inspection conditions, and a necessary image processing algorithm Pgm that is stored in association with the current article type is extracted from the image processing algorithm storage unit 34 according to the inspection items (C1 to Cm) and is incorporated into the inspection processing unit 32 (Step S12).

Then, NG image combination conditions in the sorting check image generation unit 40 and other inspection conditions are set according to the set number of inspection items and the number of discharge directions of the sorting unit 70 (Step S13).

Then, the sorting check sample Ps of the good article passes through the inspection unit 20, and the pre-inspection article detection sensor 26 detects the article (Step S14). Then, when the required determination time Tj until imaging, image combination, and a determination process has elapsed (Step S15), it is determined whether or not the signal output timing is appropriate (OK/NG) based on whether or not the sorting command signal RJ can be output until the timer measurement of the sorting delay time T3 is completed in this stage (Step S16). When the timing is appropriate (OK in Step S16), the sorting command signal RJ is output (Step S17). When the timing is not appropriate (NG in Step S16), the timer measurement completion timing of the sorting delay time T3 is corrected to be delayed to the time point t4' that is delayed from the time point t4 by a predetermined adjustment unit time or is corrected to be delayed to the value of the sorting delay time T3 whose setting value has been input (Step S18).

Then, immediately after the sorting command signal RJ is output at the delay time expiration time point t4' that has been corrected to be delayed, the timer measurement of the sorting operation time T4 is started, the sorting operation of the sorting unit 70 is executed, and it is determined whether or not the sorting operation time T4 is appropriate (Step S20). When it is determined that the sorting operation time T4 is appropriate (OK in Step S20), it is determined whether or not the number of sorting check samples Ps of the good article used or the number of times the sorting check sample Ps of the good article is used has reached a number i (Step S22). When it is determined that the number of sorting check samples Ps of the good article used or the number of times the sorting check sample Ps of the good article is used has not reached the number i, the number i is incremented (Step S23). Then, the timing adjustment process in Step S14 and the subsequent steps is repeatedly executed.

On the other hand, when the sorting operation time T4 is not appropriate (NO in Step S20), the timer measurement completion timing of the sorting operation time T4 is corrected to be delayed to the time point t6' that is delayed from the time point t6 by a predetermined adjustment unit time or a time point that is further delayed by the predetermined adjustment unit time, or is corrected to be delayed to the value of the sorting operation time T4 whose setting value has been input (Step S21).

As described above, in the X-ray inspection device 1 according to the present embodiment, when the determination unit 35 obtains determination data Img for the presence or absence of defects and defect types based on the results of predetermined image processing on the sample inspection image Dps(0) of the sorting check sample Ps of the good article by the image processing unit 33, sorting check pseudo NG images Dps(1) and Dps(2) as sample inspection images are generated such that the determination result (OK/NG) of the determination unit 35 based on the determination data Img indicates a defect (NG) for the discharge direction set by the sorting information setting unit 47. Therefore, regardless of the number of discharge directions set in the sorting information setting unit 47, it is not necessary to prepare a defective article sample or a pseudo NG article for each inspection item, and it is possible to easily, quickly, and accurately set the timing of the sorting operation for the discharge direction for each inspection item.

In addition, in the present embodiment, the images C1, C2, and C3 of predetermined defective portions stored in the NG image storage unit 41 are added and combined with the sorting check sample image Dps(0) of the good article to generate the sorting check pseudo NG image Dps(1) or Dps(2). Therefore, the sorting check pseudo NG image Dps(1) or Dps(2) showing that the article is to be distributed in the set discharge direction based on the determination result of the determination unit 35 is generated only by loading the sorting check sample Ps of the good article in the same manner as in the normal inspection operation. As a result, it is possible to easily, quickly, and accurately set the timing of the sorting operation for the discharge direction for each inspection item.

Further, the sorting information setting unit 47 sets the sorting timing using the sorting delay time T3 and the sorting operation time T4, in addition to setting the discharge direction, and the sorting operation control unit 45 causes the sorting unit 70 to execute the sorting operation based on the sorting timing set by the sorting information setting unit 47. Therefore, since the sorting timing corresponding to the discharge direction can be set, sorting can be executed by a more accurate sorting operation based on the sorting timing.

In addition, in the present embodiment, when the article P is sorted in each discharge direction by the sorting unit 70 such that a good article is moved straight and a defective article is sorted to be discharged, according to the inspection result of the quality state of the article P, the good article passage detection sensor 77 and the discharged defective article detection sensor 78, which are, for example, photoelectric sensors, are provided as product recognition means that recognizes the article P, and the sorting operation control unit 45 causes the sorting unit 70 to perform the sorting operation at the sorting timing (time point t4' corrected to be delayed) corrected to be delayed in consideration of the provisional sorting timing (time point t4) or the transport timing based on the transport speed of the article, and causes the sorting information setting unit 47 and the inspection processing unit 32 to set the provisional sorting timing as the sorting timing when it is recognized by the good article passage detection sensor 77 and the discharged defective article detection sensor 78 that the corresponding sorting operation is correctly performed in a predetermined discharge direction. Therefore, when it is recognized by the good article passage detection sensor 77 and the discharged defective article detection sensor 78 that the article P has been correctly sorted in a predetermined discharge direction, the sorting information setting unit 47 sets the provisional sorting timing based on the transport speed as the sorting timing. Therefore, it is possible to execute a more reliable operation check.

As described above, according to the present invention, it is possible to provide the X-ray inspection device 1 that can easily, quickly, and accurately set and adjust the timing of the sorting operation, without using a defective article sample or a pseudo NG article for each inspection item.

In the present embodiment, the sorting unit 70 is a flipper-type sorter using the sorting arms 73A and 73B. However, the sorting unit 70 may be a pusher-type sorter that pushes out the article P, which has reached the transport position detected by the pre-sorting article detection sensor 76 in a direction orthogonal to the transport direction, an air-blowing-type sorter that pushes out or blows away the article P in the direction orthogonal to the transport direction with wind pressure load caused by the blowing of compressed air, or various types of sorter that can discharge the NG article to the outside of the transport path. In this case, the main setting parameters may also change. In addition, when the setting of the parameters is insufficient in the normal adjustment range, it is possible to move the installation position of the sorting unit 70 to the downstream side or to change the sorter of the sorting unit 70 to a different type. Furthermore, it goes without saying that, when the fluid pressure-operated cylinder is used in the sorting unit 70 as in one embodiment, a rotary type can be used instead of a direct-acting type, or an electric cylinder can be used instead of the fluid pressure-operated cylinder.

In addition, in the present example, the sorting unit 70 sorts and discharges defective articles to one side of the sorting conveyor 13. However, the sorting unit 70 may sort and discharge defective articles to both sides. A plurality of sorting units 70 that discharge articles in the same direction may be disposed at different positions in the article transport direction, or a plurality of sorting units of other types of sorter may be installed in the transport direction and may execute sorting operations corresponding to a plurality of determination results at different positions in the transport direction.

As described above, according to the present invention, it is possible to provide an X-ray inspection device that can easily, quickly, and accurately set and adjust the timing of the sorting operation without using a defective article sample or a pseudo NG article for each inspection item. The present invention is useful for an X-ray inspection device including an inspection unit that performs image processing on an X-ray image of an article obtained by X-ray imaging and performs X-ray inspection and a sorting unit that executes a sorting operation in a discharge direction corresponding to the inspection result of the inspection unit.

### DESCRIPTION OF REFERENCE NUMERALS AND SIGNS

1: X-ray inspection device

10: Transport unit

11: Front-stage conveyor

12: Inspection conveyor

12a: Belt running section

13: Sorting conveyor

20: Inspection unit

21: X-ray generator

22: X-ray tube

23: X-ray detector

26: Pre-inspection article detection sensor

30: Control unit

31: Inspection image acquisition unit

32: Inspection processing unit

33: Image processing unit

34: Image processing algorithm storage unit

35: Determination unit

40: Sorting check image generation unit

41: NG image storage unit

42: NG image generation unit

45: Operation control unit (sorting operation control unit)

46: Operation check determination unit

47: Sorting information setting unit (information setting unit)

51: Display Unit

52: Operation Unit

60: Operation screen

61: Operation state display region

62: Setting information display region

63: Selection operation display region

64: Operation button display region

65: Operation button (sorting direction selection operation button)

66: Operation button (setting and adjustment operation button)

70: Sorting unit

71: Support frame

72: Discharge mechanism

73A, 73B: Sorting arm

75: Drive circuit

76: Pre-sorting article detection sensor

77: Good article passage detection sensor (product recognition means)

78: Discharged defective article detection sensor (product recognition means)

C1, C2, C3: NG feature image

CYL1, CYL2: Air cylinder

Dps: Sorting check pseudo image

Dps(0): Good article sample image

Dps(1): Sorting check pseudo NG image (sorting check pseudo image obtained by combining NG feature images of plurality of types)

Dps(2): Sorting check pseudo NG image (sorting check pseudo image obtained by combining NG feature images of various types)

Dpx: Captured image data

Dpx (OK): Captured image data of sorting check sample of good article

M1, M2: Motor

P: Article

Ps: Sorting check sample of good article

Q1: Good article partial image feature

RJ1: Sorting command signal (for discharging transport NG article)

RJ2: Sorting command signal (for discharging defective article)

RJ3: Sorting command signal (for passing allowable good article)

SOL1, SOL2: Operation signal

t0: Time point (time point at which leading end of article is detected before inspection)

t1: Time point (imaging time point)

t2: Time point (time point at which image processing and image analysis are performed)

t3: Time point (determination process completion time point)

t4: Time point (timer measurement completion time point of sorting delay time, delay time expiration time point, time point at which sorting command signal is output)

t4’: Time point (delay time expiration time point at time of delay correction)

t5: Time point (timer measurement start time point of sorting operation time at time of sorting delay time correction)

t6: Time point (timer measurement completion time point of sorting operation time, operation time expiration time point)

t6’: Time point (timer measurement completion time point of sorting operation time at time of delay correction)

t7: Time point (timer measurement completion time point of sorting check delay time)

t8: Time point (time point at which discharge by discharged defective article detection sensor is detected)

t9: Time point (timer measurement completion time point of sorting check operation time)

T3: Sorting delay time

T4: Sorting operation time

T7: Sorting check delay time

T9: Sorting check operation time

Tj: Required determination time

V1, V2: Valve (supply and discharge control valve, direction control valve)

What is claimed is:

1. An X-ray inspection device comprising:
an image processing unit that performs predetermined image processing on an X-ray inspection image obtained by irradiating a transported article with X-rays and detecting the X-rays transmitted through the article with an X-ray detector and outputs determination data indicating a quality state of the article;
a determination unit that determines whether or not the article is defective based on the determination data;
a sorting information setting unit that sets a discharge direction corresponding to a determination result of the determination unit;
a sorting unit that sorts the article in the discharge direction set by the sorting information setting unit according to the determination result of the determination unit;
a sorting operation control unit that controls a sorting operation of the sorting unit on the article at a predetermined sorting timing based on the determination result of the determination unit and the setting of the sorting information setting unit; and
a sorting check image generation unit that uses a sorting check sample as the article, generates a sorting check pseudo image showing that the article is to be discharged in a predetermined discharge direction set by the sorting information setting unit based on the determination result of the determination unit, based on an X-ray inspection image of the sorting check sample, and outputs the sorting check pseudo image to the image processing unit.

2. The X-ray inspection device according to claim 1,
wherein the sorting check image generation unit includes an NG image storage unit that stores an image of a predetermined defective portion determined to be discharged in the predetermined discharge direction and an NG image generation unit that adds the image of the predetermined defective portion stored in the NG image storage unit to the X-ray inspection image of the sorting check sample of a good article to generate the sorting check pseudo image.

3. The X-ray inspection device according to claim 1,
wherein the sorting information setting unit further sets the sorting timing, and
the sorting operation control unit controls the sorting operation of the sorting unit based on the sorting timing set by the sorting information setting unit.

4. The X-ray inspection device according to claim 3, further comprising:
product recognition means for recognizing the article when the article is sorted in the predetermined discharge direction by the sorting unit,
wherein the sorting operation control unit causes the sorting unit to perform a sorting operation at a provisional sorting timing based on a transport speed when the article is transported and sets the provisional sorting timing as the sorting timing in the sorting information setting unit when the article correctly sorted in the predetermined discharge direction is recognized by the product recognition means.

5. The X-ray inspection device according to claim 2,
wherein the sorting information setting unit further sets the sorting timing, and
the sorting operation control unit controls the sorting operation of the sorting unit based on the sorting timing set by the sorting information setting unit.

6. The X-ray inspection device according to claim 5, further comprising:
product recognition means for recognizing the article when the article is sorted in the predetermined discharge direction by the sorting unit,
wherein the sorting operation control unit causes the sorting unit to perform a sorting operation at a provisional sorting timing based on a transport speed when the article is transported and sets the provisional sorting timing as the sorting timing in the sorting information setting unit when the article correctly sorted in the predetermined discharge direction is recognized by the product recognition means.
